(19) United States
(12) Patent Application Publication
(10) Pub. No.: US 2025/0159629 A1
(43) Pub. Date: May 15, 2025

(54) TIME SYNCHRONIZATION METHOD FOR WIRELESS LOAD TESTING SYSTEM

(71) Applicant: Shaanxi Electric Appliance Institute, Xi'an (CN)

(72) Inventors: Chaoying ZHANG, Xi'an (CN); Wei LI, Xi'an (CN); Guoxuan MA, Xi'an (CN); Zhongbing ZHAO, Xi'an (CN); Weijian LIANG, Xi'an (CN); Jingyi REN, Xi'an (CN)

(21) Appl. No.: 18/954,451

(22) Filed: Nov. 20, 2024

Related U.S. Application Data
(63) Continuation of application No. PCT/CN2023/135751, filed on Dec. 1, 2023.

(30) Foreign Application Priority Data
Nov. 15, 2023 (CN) 2023115241601.0

(51) Int. Cl. H04W 56/00; H04J 3/06

(52) U.S. Cl. CPC H04W 56/0015; H04J 3/0602; H04J 3/0658

(57) ABSTRACT

A time synchronization method for a wireless load testing system includes two stages: a stage of constructing a wireless sensor network system and a stage of suppressing communication delay to achieve precise network-wide time synchronization. The method employs a relative skew estimator based on Bayesian estimation theory to suppress the effect of time delay in wireless communication, thereby enhancing the estimation accuracy of the relative skew estimator while reducing memory requirements. By applying the average consensus protocol, high-precision network-wide time synchronization is achieved, and the overall method enhances the robustness to time delay and has higher accuracy. The method solves the problems of reduced time synchronization accuracy and time synchronization failure of partial sub-nodes due to time delay of the traditional time synchronization algorithms in complex spatial layout.

### CROSS REFERENCE TO RELATED APPLICATIONS

This application is a continuation application of international application number PCT/CN2023/135751, filed December, 2023, which claims priority to Chinese patent application 2023115241601, filed on Nov. 15, 2023. The contents of these applications are incorporated herein by reference in their entirety.

### TECHNICAL FIELD

The present disclosure relates to the technical field of wireless sensor networks for aircraft load measurement, and in particular to a time synchronization method for a wireless load testing system.

### BACKGROUND

A number of distributed time synchronization algorithms have been proposed in conventional wireless sensor networks. These algorithms have robustness to unreliable communication links and adaptability to dynamic network topology, but all ignore the effect of communication delay on time information. In practical wireless sensor networks, the communication delay cannot be ignored, and is a fundamental limitation for time synchronization, which greatly affects the accuracy of time synchronization and the efficiency of time synchronization methods. The traditional time synchronization algorithms have the problems of reduced time synchronization accuracy and time synchronization failure of partial sub-nodes due to time delay in complex spatial layout.

### SUMMARY

The present disclosure provides a time synchronization algorithm for a wireless load testing system, which can precisely achieve the network-wide time synchronization, solves the problems of reduced time synchronization accuracy and time synchronization failure of partial sub-nodes due to time delay of the traditional time synchronization algorithms in complex spatial layout, and is applicable to point-to-multipoint wireless networks where multiple points do not communicate with each other directly.

The present disclosure provides a time synchronization method for a wireless load testing system, including two stages: a stage of constructing a wireless sensor system; and a stage of suppressing communication delay to achieve precise network-wide time synchronization.

The stage of constructing a wireless sensor system includes constructing a network model based on a consensus algorithm, constructing a clock model, updating compensation parameters of virtual logical clocks of nodes, and proposing a timestamp exchange mechanism based on a pseudo-periodic communication scheme.

The stage of suppressing communication delay to achieve precise network-wide time synchronization mainly includes: proposing a relative skew estimation method based on Bayesian theory to perform relative skew estimation; performing skew and offset compensation.

Compared with the prior art, the beneficial effects of the present disclosure are: (1) the relative skew estimator based on Bayesian estimation theory is employed to suppress the effect of time delay in wireless communication, thereby enhancing the estimation accuracy of the relative skew estimator while reducing memory requirements; (2) by applying the average consensus protocol, high-precision network-wide time synchronization is achieved; (3) the overall method enhances the robustness to time delay and has higher accuracy.

### BRIEF DESCRIPTION OF THE DRAWINGS

The foregoing and other objects, features, and advantages of the present disclosure will become more apparent from the following detailed description of exemplary embodiments of the present disclosure taken in conjunction with the accompanying drawings, in which like reference numerals generally refer to the same parts throughout the exemplary embodiments of the present disclosure.

FIG. 1 is a flowchart of an exemplary embodiment of the present disclosure;

FIG. 2 is an exemplary wireless network node distribution diagram; and

FIG. 3A is a block diagram of a stage of constructing a wireless sensor network system.

FIG. 3B is a block diagram of a stage of suppressing communication delay to achieve precise network-wide time synchronization.

FIG. 4 is a structure diagram of a time synchronization method for wireless load testing in the present application.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

Preferred embodiments of the present disclosure will be described in more detail below with reference to the accompanying drawings. While preferred embodiments of the present disclosure are illustrated in the accompanying drawings, it should be understood that the present disclosure may be embodied in various forms and should not be construed as limited to the embodiments set forth herein. Rather, these embodiments are provided so that the present disclosure will be thorough and complete, and will fully convey the scope of the disclosure to those skilled in the art.

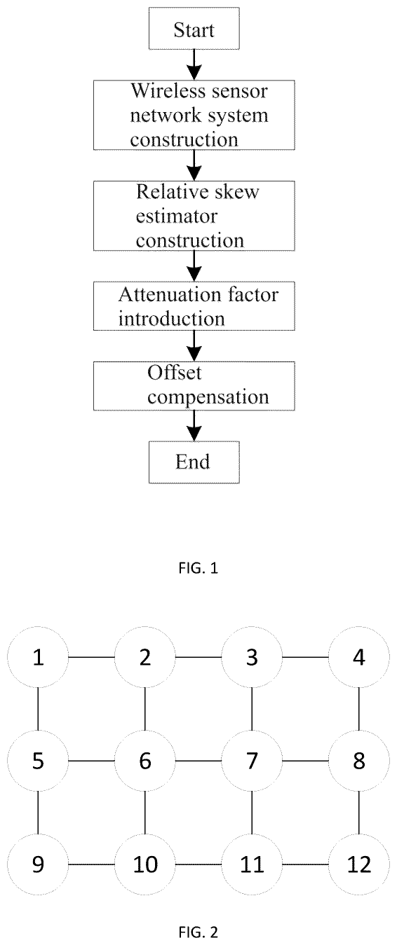

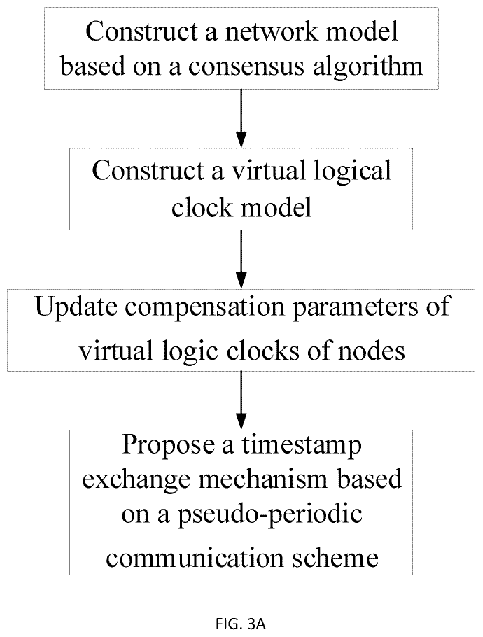

The present disclosure provides a time synchronization method for a wireless load testing system. A flowchart of an exemplary embodiment is shown in FIG. 1. An exemplary wireless load testing system includes a central node and 12 sub-nodes, and transmits load data to an upper computer through wireless communication, as shown in FIG. 2.

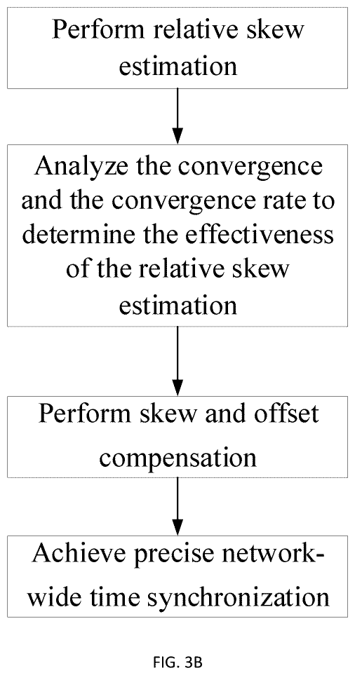

The method according to the present disclosure mainly includes two stages: a stage of constructing a wireless sensor system, and a stage of suppressing communication delay to achieve precise network-wide time synchronization. A flowchart of each stage is shown in FIG. 3.

The stage of constructing the wireless sensor system includes: constructing a network model based on a consensus algorithm, constructing a clock model, updating compensation parameters of virtual logical clocks of nodes, and proposing a timestamp exchange mechanism based on a pseudo-periodic communication scheme.

The steps of the stage of constructing the wireless sensor system are as follows:

S1, constructing the network model based on the consensus algorithm.

Assuming communication topology is an undirected graph G=(N,ε) in a wireless network, where N={1, 2, . . . , N}represents a set of sensor nodes, and ε⊆N×N represents a set of effective communication links. αᵢⱼ represents a non-empty adjacency element, and if and only if there is a directed link in G, a set of direct neighbor nodes of a sub-node i can be expressed as Nᵢ={j|(i,j)}∈ε, where (i,j)∈ε represents that the node i can communicate with a node j in one hop. For the state of a certain sub-node i, the consensus algorithm can be adopted to construct the following linear model:

$${x}_{i} ( k + 1 ) = {x}_{i} ( k ) + {\sum }_{j ∈ {N}_{i}} {α}_{ij} [ {x}_{j} ( k ) - {x}_{i} ( k ) ] ;$$

where k is the number of iterations; and xᵢ(k) represents the linear model obtained after k iterations of the node i. if the linear model based on the consensus algorithm is applied to a clock update equation, the clocks of the nodes can be driven to a common clock.

S2, constructing a node virtual logic clock updating model based on a timestamp exchange mechanism based on a pseudo-periodic communication scheme.

S21, constructing a clock model.

Each sensor node has a local hardware clock whose first-order dynamic function is expressed as:

$${C}_{i} ( t ) = {α}_{i} t + {β}_{i} ;$$

where cᵢ(t) is the hardware clock reading at absolute reference time t, and αᵢ and βᵢ are local hardware clock skew and offset, respectively; the clock model is established as follows by using hardware clock data of any two nodes to obtain indirect information of the nodes:

$${C}_{j} ( t ) = \frac{{α}_{j}}{{α}_{i}} {c}_{j} ( t ) + ( {β}_{j} - \frac{{α}_{j}}{{α}_{i}} {β}_{i} ) = {α}_{ij} {c}_{j} ( t ) + {β}_{ij} ;$$

$$where , {α}_{ij} = \frac{{α}_{j}}{{α}_{i}} , {β}_{ij} = {β}_{j} - \frac{{α}_{j}}{{α}_{i}} {β}_{i} .$$

Since the local hardware clock cannot be manually modified, it is proposed that the node maintains a virtual logic clock to represent the synchronization time. The model is as follows:

$${\hat{c}}_{j} ( t ) = {α}_{i} {c}_{i} ( t ) + {β}_{i} = {α}_{i} {α}_{i} ( t ) + {α}_{i} {β}_{i} + {β}_{i} ;$$

where, αᵢ and βᵢ represent skew compensation and offset compensation, respectively, and αᵢ=αiαᵢ and βᵢ=αiβ₁+βᵢ are defined as virtual logical clock skew and offset, respectively.

S22, updating compensation parameters of virtual logical clocks of nodes.

The compensation parameters of the virtual logic clock model are updated periodically and iteratively, such that the logic clocks of each sensor node approximate a common clock, c̅(t)=α̅t+β̅.

The compensation parameters of the virtual logic clocks of the nodes are updated, such that (αi,βᵢ) satisfies:

$$\{ \begin{matrix}{lim}_{k \to ∞} {α}_{i} ( k ) {α}_{i} = \overline{α} \\ {lim}_{k \to ∞} {α}_{i} ( k ) {β}_{i} + {β}_{i} ( k ) = \overline{β}\end{matrix} ;$$

wherein, c̅(t) represents the common clock, and α̅ and β̅ represent the updated compensation parameters of the virtual logic clocks of the nodes.

S23, proposing a timestamp exchange mechanism based on a pseudo-periodic communication scheme.

Each node broadcasts time information with an MAC layer timestamp to neighbor nodes in each synchronization period T. The neighbor nodes record local clocks immediately after receiving the information. Assuming a k-th broadcast of the node i with communication delay to a neighbor node j, cᵢ(tₖⁱ)=kT represents the k-th transmission time of the node i, where represents the transmission instant at the corresponding absolute moment, and assuming the node j obtains the k-th message at its local time cⱼ(tₖ^{ij}), where tₖⁱ represents the instant time at which the node j receives the message within the absolute time, so tₖ^{ij}>tₖⁱ, and

$${t}_{k}^{ij} = {t}_{k}^{i} + {d}_{ij} ( {t}_{k}^{ij} ) = {t}_{k}^{i} + {d}_{ij}^{r} ( {t}_{k}^{ij} ) + {d}_{ij}^{f} , k = 1 , 2 , … ;$$

where, dᵢⱼ(tₖ^{ij}) represents the communication delay, and is composed of random delay dᵢⱼ^{r}(tₖ^{ij}) and fixed delay dᵢⱼ^{f}.

Based on the communication delay, it is assumed that for any communication link between any two nodes, the delay exists as a positive and bounded independent random variable, i.e., 0<dᵢⱼ(tₖ^{ij})≤M_{d}, where M_{d} is a positive real constant; in addition, it is assumed that each node neither updates the virtual logical clock of the node nor obtains the time information sent by the neighbor nodes of the node until a time duration is greater than M_{d}.

S3, constructing a relative skew estimator based on Bayesian theory, and estimating undetermined parameters in the updating the virtual logic clocks of the nodes, such that the logic clocks of each sensor node approximate a common clock.

Including performing relative skew estimation, and performing skew and offset compensation.

In order to offset the effect of delay, a relative skew estimation method based on Bayesian theory is proposed.

Assuming each node i periodically broadcasts time information to its neighbor node j, where the time information includes a node ID, an information transmission sequence number, a current hardware clock value, a logical skew compensation value and an offset compensation value. Considering that the communication delay includes random delay and fixed delay, the time information exchanged between the node i and the node j is reconstructed as:

$${c}_{j} ( {t}_{k}^{ij} ) = {α}_{ij} {c}_{i} ( {t}_{k}^{i} ) + {β}_{ij} + {d}_{ij}^{r} ( {t}_{k}^{ij} ) + {d}_{ij}^{f} .$$

Analyzing the effect of other unknown parameters of relative skew by subtracting the time information, to obtain the following formula:

$${c}_{j} ( {t}_{k}^{ij} ) - {c}_{j} ( {t}_{k - 1}^{ij} ) = {α}_{ij} ( {c}_{i} ( {t}_{k}^{i} ) - {c}_{i} ( {t}_{k - 1}^{i} ) ) + ( {d}_{ij}^{r} ( {t}_{k}^{ij} ) - {d}_{ij}^{r} ( {t}_{k - 1}^{ij} ) ) .$$

In the actual time synchronization process, when a message from the node i is not received by the neighbor node j within the time duration M_{d}, the synchronization message will be considered as discarded.

Based on Bayesian estimation theory, an error function of the to-be-estimated parameter αᵢⱼ is expressed as e=αᵢⱼ−αᵢⱼ.

And then a quadratic function is defined as C(e)=e²=(αᵢⱼ−αᵢⱼ)².

The relative skew is estimated by a Bayesian mean square error R=E(C(e))=E((αᵢⱼ−αᵢⱼ)²).

By applying the relative skew to a probability density function p(Δcⱼ(n),αᵢⱼ), according to Bayesian principle, it can be obtained that p(Δcⱼ (n), αᵢⱼ)=p(αᵢⱼ|Δcⱼ(n)pΔcⱼ(n)).

So,

$${B}_{mse} ( {α}_{ij} ) = \int ( \int {( {α}_{ij} - {α}_{ij} )}^{2} p ( {α}_{ij} \vert Δ {c}_{j} ( n ) d ( {α}_{ij} ) ) \times p ( Δ {c}_{j} ( n ) ) d ( ( Δ {c}_{j} ( n ) ) .$$

Since p(Δcⱼ(n))≥0 holds for all Δcⱼ(n), if the integral in parentheses can be minimized for each Δcⱼ(n), then Bₘₛₑ will be minimized, and the estimator of minimizing Bₘₛₑ is the average of the posterior joint conditions of αᵢⱼ=E(αᵢⱼ|Δcⱼ(n)).

$${α}_{ij} = E ( {α}_{ij} \vert Δ {c}_{j} ( n ) ) = \frac{{σ}_{{α}_{ij}}^{2} T}{( N - 1 ) {T}^{2} {σ}_{{α}_{ij}}^{2} + 2 {σ}^{2}} {\sum }_{n = 1}^{N - 1} Δ {c}_{j} ( n ) + \frac{2 {σ}^{2} {μ}_{{α}_{ij}} T}{( N - 1 ) {T}^{2} {σ}_{{α}_{ij}}^{2} + 2 {σ}^{2}} .$$

The equivalent recursive solution to the above formula is as follows:

$${α}_{ij} ( n ) = {α}_{ij} ( n - 1 ) - \frac{{σ}_{{α}_{ij}}^{2} {T}^{2}}{( n - 1 ) {T}^{2} {σ}_{{α}_{ij}}^{2} + 2 {σ}^{2}} \times ( {α}_{ij} ( n - 1 ) - \frac{Δ {c}_{j} ( n - 1 )}{T} .$$

In the case of bounded delay, the bounded convergence of the time synchronization algorithm depends on the convergence rate and attenuation rate of the relative skew estimation error. The convergence and convergence rate of the above formula are analyzed to determine the effectiveness of the relative skew estimation. The analysis method is as follows:

$${α}_{ij} ( n ) = \frac{{σ}_{{α}_{ij}}^{2} {T}^{2} [ {c}_{j} ( {t}_{n}^{ij} ) - {c}_{j} ( {t}_{n - 1}^{ij} ) + … + {c}_{j} ( {t}_{2}^{ij} ) - {c}_{j} ( {t}_{1}^{ij} ) ]}{( n - 1 ) {T}^{2} {σ}_{{α}_{ij}}^{2} + 2 {σ}^{2}} + \frac{2 {σ}^{2} {μ}_{{α}_{ij}}}{( n - 1 ) {T}^{2} {σ}_{{α}_{ij}}^{2} + 2 {σ}^{2}} .$$

After the hardware local time cⱼ(tₖ^{ij}) of the k-th data packet received by the node j is substituted into the above formula, it can be obtained that αᵢⱼ(n)=αᵢⱼ(1+εᵢⱼ(n)).
when,

$${ε}_{ij} ( n ) = \frac{{σ}_{{α}_{ij}}^{2} {T}^{2} [ {d}_{ij}^{r} ( {t}_{n}^{ij} ) - {d}_{ij}^{r} ( {t}_{1}^{ij} ) ] + 2 {σ}^{2} {μ}_{{α}_{ij}}}{( ( n - 1 ) {T}^{2} {σ}_{{α}_{ij}}^{2} + 2 {σ}^{2} ) {α}_{ij}} + \frac{2 {σ}^{2}}{( n - 1 ) {T}^{2} {σ}_{{α}_{ij}}^{2} + 2 {σ}^{2}} ;$$

to obtain,

$${ε}_{ij} ( n ) \leq \vert \frac{2 {σ}_{{α}_{ij}}^{2} {T}^{2} {M}_{d} + 2 {σ}^{2} {μ}_{{α}_{ij}}}{{α}_{ij} ( n - 1 ) {T}^{2} {σ}_{{α}_{ij}}^{2}} \vert .$$

Therefore, for any n∈N⁺,

$${ε}_{ij} ( n ) \leq \vert \frac{2 {σ}_{{α}_{ij}}^{2} {T}^{2} {M}_{d} + 2 {σ}^{2} {μ}_{{α}_{ij}}}{{α}_{ij} ( n - 1 ) {T}^{2} {σ}_{{α}_{ij}}^{2}} \vert .$$

The convergence speed of εᵢⱼ(n) is equal to O(1/(n-1)), so lim_{n→∞}\hat{α}ᵢⱼ(n)=αᵢⱼ, which proves the effectiveness of the relative skew estimator.

S4, updating logical skew compensation and offset compensation of the nodes.

When the node j obtains the n-th synchronization packet from the node i, the node j performs the n-th skew and offset compensation update at tₙ^{ij} using the following update rules.

$${α}_{j} ( {t}^{+} ) = ( 1 - a ( n ) {ρ}_{a} ) {α}_{j} ( t ) + a ( n ) {ρ}_{a} {α}_{ij}^{- 1} ( n ) {α}_{i} ( t ) ;$$

$$and$$

$${β}_{j} ( {t}^{+} ) = {β}_{j} ( t ) + a ( n ) {ρ}_{0} [ {\hat{c}}_{i} ( {t}_{n}^{i} ) - {\hat{c}}_{j} ( {t}_{n}^{ij} ) ] , i ∈ {N}_{j} , t = {t}_{n}^{ij} ;$$

where, ρ_{α}∈(0,1) and ρ₀∈(0,1) are tuning parameters, α(n)∈(n-1)^{-u} is an attenuation factor, where u∈(0,1), is αⱼ the skew compensation of the node i at t, and the initial condition for any node j∈N is set to αⱼ(0)=1 and βⱼ(0)=1. The introduction of a(n) into the above formula is to further weaken the adverse effect of the relative skew estimation error, so as to ensure the consistency of logical skew under communication delay.

The time synchronization method for wireless load testing system is processed by a time synchronization equipment for wireless load testing system.

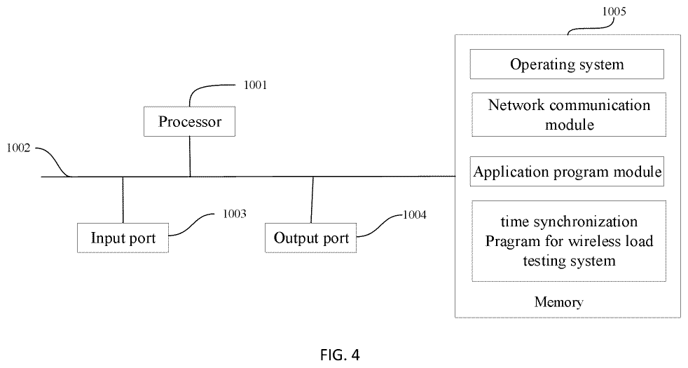

As shown in FIG. 4, the time synchronization equipment for wireless load testing system includes: a processor 1001 (such as Central Processing Unit, CPU), a communication bus 1002, an input port 1003, an output port 1004, and a memory 1005. Among them, the communication bus 1002 is used to achieve connection communication between these components; the input port 1003 is used for data input; and the output port 1004 is used for data output, and the memory 1005 can be high-speed RAM memory or non volatile memory, such as disk memory, non-transitory computer-readable storage medium. Optionally, memory 1005 is a storage device independent of the aforementioned processor 1001.

The memory 1005, as a non-volatile readable storage medium, may include an operating system, network communication module, application program module, and a time synchronization equipment for wireless load testing system. The network communication module is mainly used to connect to servers and communicate data with them; And processor 1001 is used to call the program to process the method stored in memory 1005, and execute all steps of the time synchronization method for wireless load testing system mentioned above.

The above technical solutions are only exemplary embodiments of the present disclosure. For those skilled in the art, various modifications and variations can be made to the disclosed methods and principles of the present disclosure, and are not limited to the methods described in the above specific embodiments of the present disclosure. Accordingly, the foregoing description is intended to be illustrative only and not to be taken in a limiting sense.

What is claimed is:

1. A time synchronization method for a wireless load testing system, comprising the following steps:
S1, constructing a network model based on a consensus algorithm for updating virtual logic clocks of nodes;
S2, constructing a node virtual logic clock updating model based on a timestamp exchange mechanism based on a pseudo-periodic communication scheme;
S3, constructing a relative skew estimator based on Bayesian theory, and estimating undetermined parameters in the updating the virtual logic clocks of the nodes, such that the logic clocks of each sensor node approximate a common clock; and
S4, updating logical skew compensation and offset compensation of the nodes.

2. The method according to claim 1, wherein the network model based on the consensus algorithm in step S1 comprises:
assuming communication topology is an undirected graph G=(N,ε) in a wireless network, where N={1, 2, . . . , N}represents a set of sensor nodes, and ε⊆N×N represents a set of effective communication links; and αᵢⱼ represents a non-empty adjacency element, and if and only if there is a directed link in G, a set of direct neighbor nodes of a sub-node i is expressed as Nᵢ={j|(i,j)}∈ε, where (i,j)∈ε represents that the node i communicate with a node j in one hop, for the state of a certain sub-node i, the consensus algorithm is adopted to construct the following linear model:
$${x}_{i} ( k + 1 ) = {x}_{i} ( k ) + {\sum }_{j ∈ {N}_{i}} {a}_{ij} [ {x}_{j} ( k ) - {x}_{i} ( k ) ] ;$$
where k is the number of iterations; and xᵢ(k) represents the linear model obtained after k iterations of the node i. if the linear model based on the consensus algorithm is applied to a clock update equation, the clocks of the nodes are driven to a common clock.

3. The method according to claim 1, wherein the step S2 specifically comprises:
S21, constructing a clock model;
wherein, each sensor node having a local hardware clock whose first-order dynamic function is expressed as:
$${c}_{i} ( t ) = {α}_{i} t + {β}_{i} ;$$
wherein cᵢ(t) is the hardware clock reading at absolute reference time t, and αᵢ and βᵢ are local hardware clock skew and offset, respectively; the clock model is established as follows by using hardware clock data of any two nodes to obtain indirect information of the nodes:
$${c}_{j} ( t ) = \frac{{α}_{j}}{{α}_{i}} {c}_{j} ( t ) + ( {β}_{j} - \frac{{α}_{j}}{{α}_{i}} {β}_{i} ) = {α}_{ij} {c}_{j} ( t ) + {β}_{ij} ;$$
$$wherein ,$$
$${α}_{ij} = \frac{{α}_{j}}{{α}_{i}} ,$$
$${β}_{ij} = {β}_{j} - \frac{{α}_{j}}{{α}_{i}} {β}_{i} ;$$
since the local hardware clock cannot be manually modified, it is proposed that the node maintains a virtual logic clock to represent the synchronization time, the model is as follows:
$${\hat{c}}_{j} ( t ) = {α}_{i} {c}_{i} ( t ) + {β}_{i} = {α}_{i} {α}_{i} ( t ) + {α}_{i} {β}_{i} + {β}_{i} ;$$
wherein, αᵢ and βᵢ represent skew compensation and offset compensation, respectively, and αᵢ=αiαᵢ and βᵢ=αiβᵢ+βᵢ are defined as virtual logical clock skew and offset, respectively; and
S22, updating compensation parameters of virtual logical clocks of nodes;
wherein, the compensation parameters of the virtual logic clock model are updated periodically and iteratively, such that the logic clocks of each sensor node approximate a common clock, c̅(t)=α̅t+β̅;
the compensation parameters of the virtual logic clocks of the nodes are updated, such that (αᵢ,βᵢ) satisfies:
$$\{ \begin{matrix}{lim}_{k \to ∞} {α}_{i} ( k ) {α}_{i} = \overline{α} \\ {lim}_{k \to ∞} {α}_{i} ( k ) {β}_{i} + {β}_{i} ( k ) = \overline{β}\end{matrix} ;$$
wherein, c̅(t) represents the common clock, and α̅ and β̅ represent the updated compensation parameters of the virtual logic clocks of the nodes; and
S23, proposing a timestamp exchange mechanism based on a pseudo-periodic communication scheme;
wherein, each node broadcasts time information with a media access control (MAC) layer timestamp to neighbor nodes in each synchronization period T, the neighbor nodes record local clocks immediately after receiving the information;
assuming a k-th broadcast of the node i with communication delay to a neighbor node j, cᵢ(tₖⁱ)=kT represents the k-th transmission time of the node i, where tₖⁱ represents the transmission instant at the corresponding absolute moment, and assuming the node j obtains the k-th message at its local time cⱼ(tₖ^{ij}), where tₖⁱ represents the instant time at which the node j receives the message within the absolute time, so tₖ^{ij}>tₖⁱ, and
$${t}_{k}^{ij} = {t}_{k}^{i} + {d}_{ij} ( {t}_{k}^{ij} ) = {t}_{k}^{i} + {d}_{ij}^{r} ( {t}_{k}^{ij} ) + {d}_{ij}^{f} , k = 1 , 2 , … ;$$
where, dᵢⱼ(tₖ^{ij}) represents the communication delay, and is composed of random delay dᵢⱼ^{r}(tₖ^{ij}) and fixed delay dᵢⱼ^{f}; and
based on the communication delay, it is assumed that for any communication link between any two nodes, the delay exists as a positive and bounded independent random variable, 0<dᵢⱼ(tₖ^{ij})≤M_{d}, where M_{d} is a positive real constant; in addition, it is assumed that each node neither updates the virtual logical clock of the node nor obtains the time information sent by the neighbor nodes of the node until a time duration is greater than M_{d}.

4. The method according to claim 3, wherein step S3 comprises:
assuming each node i periodically broadcasts time information to its neighbor node j, where the time information includes a node identification (ID), an information transmission sequence number, a current hardware clock value, a logical skew compensation value and an offset compensation value; considering that the communication delay includes random delay and fixed delay, the time information exchanged between the node i and the node j is reconstructed as:
$${c}_{j} ( {t}_{k}^{ij} ) = {α}_{ij} {c}_{i} ( {t}_{k}^{i} ) + {β}_{ij} + {d}_{ij}^{r} ( {t}_{k}^{ij} ) + {d}_{ij}^{f} ;$$
analyzing the effect of other unknown parameters of relative skew by subtracting the time information, to obtain the following formula:
$${c}_{j} ( {t}_{k}^{ij} ) - {c}_{j} ( {t}_{k - 1}^{ij} ) = {α}_{ij} ( {c}_{i} ( {t}_{k}^{i} ) - {c}_{i} ( {t}_{k - 1}^{i} ) ) + ( {d}_{ij}^{r} ( {t}_{k}^{ij} ) - {d}_{ij}^{r} ( {t}_{k - 1}^{ij} ) ) ;$$
in the actual time synchronization process, when a message from the node i is not received by the neighbor node j within the time duration M_{d}, the synchronization message will be considered as discarded; and
based on Bayesian estimation theory, an error function of the to-be-estimated parameter αᵢⱼ is expressed as e=αᵢⱼ−αᵢⱼ;
and then a quadratic function is defined as C(e)=e²=(αᵢⱼ−αᵢⱼ)²;
the relative skew is estimated by a Bayesian mean square error R=E(C(e))=E((αᵢⱼ−αᵢⱼ)²);
by applying the relative skew to a probability density function p(Δcⱼ(n),αᵢⱼ), according to Bayesian principle, it is obtained that
$$p ( Δ {c}_{j} ( n ) , {α}_{ij} ) = p ( {α}_{ij} \vert Δ {c}_{j} ( n ) p Δ {c}_{j} ( n ) ) ;$$
$$and$$
$${B}_{mse} ( {α}_{ij} ) = \int ( \int {( {α}_{ij} - {α}_{ij} )}^{2} p ( {α}_{ij} \vert Δ {c}_{j} ( n ) d ( {α}_{ij} ) ) \times p ( Δ {c}_{j} ( n ) ) d ( ( Δ {c}_{j} ( n ) ) ;$$
since p(Δcⱼ(n))≥0 holds for all Δcⱼ(n), if the integral in parentheses is minimized for each Δcⱼ(n), then Bₘₛₑ will be minimized, and the estimator of minimizing Bₘₛₑ is the average of the posterior joint conditions of
$${α}_{ij} = E ( {α}_{ij} \vert Δ {c}_{j} ( n ) ) ;$$
$$\begin{matrix}{α}_{ij} = E ( {α}_{ij} \vert Δ {c}_{j} ( n ) ) \\ = \frac{{σ}_{{α}_{ij}}^{2} T}{( N - 1 ) {T}^{2} {σ}_{{α}_{ij}}^{2} + 2 {σ}^{2}} {\sum }_{n = 1}^{N - 1} Δ {c}_{j} ( n ) + \frac{2 {σ}^{2} {μ}_{{α}_{ij}} T}{( N - 1 ) {T}^{2} {σ}_{{α}_{ij}}^{2} + 2 {σ}^{2}} ;\end{matrix}$$
an equivalent recursive solution to the above formula is as follows:
$${α}_{ij} ( n ) = {α}_{ij} ( n - 1 ) - \frac{{σ}_{{α}_{ij}}^{2} {T}^{2}}{( n - 1 ) {T}^{2} {σ}_{{α}_{ij}}^{2} + 2 {σ}^{2}} \times ( {α}_{ij} ( n - 1 ) - \frac{Δ {c}_{j} ( n - 1 )}{T} .$$

5. The method according to claim 4, wherein step S4 specifically comprises:
when the node j obtains the n-th synchronization packet from the node i, the node j performs the n-th skew and offset compensation update at tₙ^{ij} using the following update rules:
$${α}_{j} ( {t}^{+} ) = ( 1 - a ( n ) {ρ}_{a} ) {α}_{j} ( t ) + a ( n ) {ρ}_{a} {α}_{ij}^{- 1} ( n ) {α}_{i} ( t ) ;$$
$$and$$
$${β}_{j} ( {t}^{+} ) = {β}_{j} ( t ) + a ( n ) {ρ}_{0} [ \hat{{c}_{i}} ( {t}_{n}^{i} ) - {\hat{c}}_{j} ( {t}_{n}^{ij} ) ] , i ∈ {N}_{j} , t = {t}_{n}^{ij} ;$$
where, ρ_{α}∈(0,1) and ρ₀∈(0,1) are tuning parameters, α(n)∈(n-1)^{-u} is an attenuation factor, where u∈(0,1), is αⱼ the skew compensation of the node i at t, and the initial condition for any node j∈N is set to αⱼ(0)=1 and βⱼ(0)=1.
